(19) United States
(12) Patent Application Publication
(10) Pub. No.: US 2016/0050700 A1
(43) Pub. Date: Feb. 18, 2016

(54) FIRST ELECTRONIC APPARATUS CAPABLE OF ACTIVELY PAIRING WITH SECOND ELECTRONIC APPARATUS FOR WIRELESS COMMUNICATION AND CORRESPONDING METHOD

(71) Applicant: PixArt Imaging Inc., Hsin-Chu City (TW)

(72) Inventors: Ren-Hau Gu, Hsin-Chu City (TW); Ming-Tsan Kao, Hsin-Chu City (TW)

(21) Appl. No.: 14/607,091

(22) Filed: Jan. 28, 2015

(30) Foreign Application Priority Data
Aug. 12, 2014 (TW) 103127661

(51) Int. Cl. H04W 76/02; H04W 4/00; H04B 10/116

(52) U.S. Cl. CPC H04W 76/023; H04B 10/116; H04W 4/008

(57) ABSTRACT

A first electronic apparatus capable of pairing with a second electronic apparatus for wireless communication includes a light sensor and a processing circuit. The light sensor is used for detecting light emitted by the second electronic apparatus. The processing circuit is coupled the light sensor and used for decoding the detected light to generate decoded pairing data. The first and second electronic apparatuses pair successfully according to the decoded pairing data. The light carrying the pairing data is generated by the second electronic apparatus based on at least one of brightness variation(s), color variation(s), and pattern variation(s).

### BACKGROUND OF THE INVENTION

1. Field of the Invention

The invention relates to a wireless communication pairing scheme, and more particularly to a first electronic apparatus capable of pairing with a second electronic apparatus for wireless communication and a corresponding method.

2. Description of the Prior Art

Generally speaking, before two electronic devices (e.g. an optical mouse device and a display device of a host computer) communicate with each other via a wireless communication scheme such as Bluetooth communication technology, it is necessary to synchronize and pair the two electronic devices with each other so that data transmission and sharing or corresponding operation can be executed. Usually, pairing data for Bluetooth communication between two communication devices is configured in advance before the communication devices leave the factory. The host of the communication devices is usually arranged to store pairing data for the slave in advance. For example, the host may store PIN code or address. However, for a group of multiple host computers and multiple optical mouse devices, a host computer cannot store Bluetooth pairing data of a specific optical mouse device in advance since it is not sure that a user would like to use the specific optical mouse device to control and operate this host computer. In this situation, a user needs to manually enter the Bluetooth pairing data so as to make the host computer and optical mouse device successfully pair with each other. Conventional pairing scheme for wireless communication is developed in order to reduce trouble of manually entering Bluetooth pairing data. This conventional scheme is configured to transmit the Bluetooth pairing data form the specific optical mouse device to the host computer by using the data transmission capability of near field communication (NFC) technology. Unfortunately, it is necessary for the conventional scheme to further employ an NFC device. This would significantly increase the circuit cost.

### SUMMARY OF THE INVENTION

Therefore one of the objectives of the invention is to provide a scheme capable of making a first electronic apparatus and a second electronic apparatus pair with each other for wireless communication, to solve the above-mentioned problems.

According to an embodiment of the invention, a first electronic apparatus capable of pairing with a second electronic apparatus for wireless communication is disclosed. The first electronic apparatus comprises a light sensor and a processing circuit. The light sensor is utilized for detecting light ray(s) emitted by the second electronic apparatus. The processing circuit is coupled to the light sensor and utilized for decoding the emitted light ray(s) to generate decoded pairing data and making the first electronic apparatus pair with the second electronic apparatus for the wireless communication according to the decoded pairing data. The emitted light ray(s) carrying the pairing data is/are generated by the second electronic apparatus based on at least one of brightness variation(s), color variation(s), and pattern variation(s).

According to an embodiment of the invention, a method for making a first electronic apparatus pair with a second electronic apparatus for wireless communication is disclosed. The method comprises: detecting light ray(s) emitted by the second electronic apparatus; decoding the emitted light ray(s) to generate decoded pairing data; and making the first electronic apparatus pair with the second electronic apparatus for the wireless communication according to the decoded pairing data; the emitted light ray(s) carrying the pairing data is generated by the second electronic apparatus based on at least one of brightness variation(s), color variation(s), and pattern variation(s).

According to an embodiment of the invention, a first electronic apparatus capable of actively pairing with a second electronic apparatus for wireless communication is disclosed. The first electronic apparatus comprises a processing circuit and an optical display device. The processing circuit is utilized for generating pairing data for wireless communication. The optical display device is coupled to the processing circuit and utilized for generating and emitting light ray(s) carrying the pairing data to the second electronic apparatus based on at least one of brightness variation(s), color variation(s), and pattern variation(s) according to the pairing data.

According to the embodiments of the invention, by using an electronic apparatus to encode pairing data and transmitting the pairing data on light ray(s) (e.g. brightness variation(s), color variation(s), and/or specific pattern variation(s)) emitted by a screen of a display device, another electronic apparatus can effectively detect and decode the pairing data by merely using a light sensor to sense the light ray(s) emitted from the screen, so as to make the two electronic apparatuses successfully pair with each other. It is not required for users to manually enter pairing data, and it is also not required to use an NFC device for transmitting the pairing data. Accordingly, this can reduce the circuit cost and reduce the trouble of manually entering the pairing data for the users.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a system that is capable of making an electronic apparatus pair with another electronic apparatus for wireless communication according to an embodiment of the invention.

FIG. 2 is a flowchart diagram illustrating operations of the system of wireless communication as shown in FIG. 1.

### DETAILED DESCRIPTION

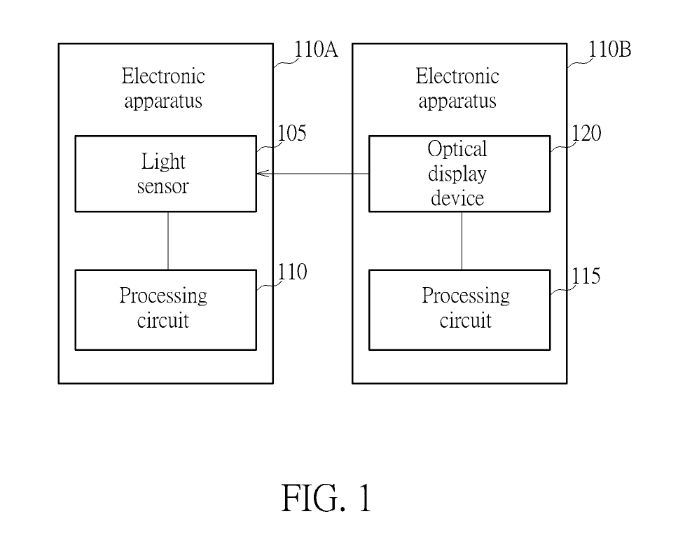

Please refer to FIG. 1, which is a diagram of a system that is capable of making an electronic apparatus 100A pair with another electronic apparatus 100B for wireless communication according to an embodiment of the invention. In this embodiment, the operation of pairing two devices for wireless communication, for example, can be implemented by using Bluetooth wireless communication or near field communication (NFC). However, this is not intended to be a limitation of the invention. In this embodiment, the electronic apparatus 100B is used for encoding pairing data for wireless communication. The pairing data for example is PIN code of Bluetooth communication or corresponding address. The electronic apparatus 100A is used for receiving the encoded pairing data and decoding the received pairing data. Through the display screen, the electronic apparatus 100B transmits the encoded pairing data on the light ray(s) emitted by the display screen to the electronic apparatus 100A. The electronic apparatus 100A senses and receives the light ray(s) emitted from the screen by using light-based sensing technology to decode the pairing data. By encoding, transmitting, and decoding the pairing data on light ray(s), the wireless communication pairing scheme disclosed in the embodiment of the invention can make the two electronic apparatuses 100A and 100B automatically and rapidly pair with each other when one electronic apparatus closes to the other. In this situation, one of the electronic apparatuses 100A and 100B is able to control the other. For example, a user may employ the electronic apparatus 100A to operate the electronic apparatus 100B. In addition, the electronic apparatuses 100A and 100B may exchange information/data with each other. Alternatively, the electronic apparatuses 100A and 100B may transmit data via one-to-one transmission. For example, the electronic apparatus 100A may be a portable device such as an optical mouse device, and the electronic apparatus 100B may be a display device. Alternatively, the electronic apparatus 100A may be a mobile communication device such as a smart phone device, and the electronic apparatus 100B may be a display device. Alternatively, the electronic apparatuses 100A and 100B may be a pair of mobile communication devices such as smart phone devices.

The electronic apparatuses 100A and 100B employ light transmission and light sensing technology so as to achieve the purpose of executing pairing for wireless communication rapidly. All modifications by employing light transmission and light sensing technology between two electronic apparatuses to achieve wireless communication pairing should fall within the scope of the invention. In addition, since the wireless communication pairing scheme disclosed in the embodiments of the invention can be automatically performed, it is not required for a user to manually enter the pairing data into one electronic apparatus for making the two electronic apparatuses 100A and 100B pair with each other successfully. Alternatively, the wireless communication pairing scheme can be actively initiated by the electronic apparatus 100A or by the electronic apparatus 100B. For example, in an example of an optical mouse device and a display device, the operation of wireless communication pairing scheme can be actively initiated by the optical mouse device or by the display device. Alternatively, in an example of a smart phone device and a display device, the operation of wireless communication pairing scheme can be actively initiated by the smart phone device or by the display device. These modifications all obey the spirits of the invention.

Specifically, as shown in FIG. 1, the electronic apparatus 100A comprises a light sensor 105 and a processing circuit 110, and the electronic apparatus 100B comprises a processing circuit 115 and an optical display device 120 including a screen. The processing circuit 115 of electronic apparatus 100B is arranged for generating and encoding pairing data for wireless communication. The optical display device 120 is coupled to the processing circuit 115 and used for generating and emitting at least one light ray carrying the pairing data or displaying at least one image carrying the pairing data based on at least one of brightness variation(s), color variation(s), and a specific pattern (or pattern variation(s)) in accordance with the pairing data. The light sensor 105 (e.g. an image sensor) of electronic apparatus 100A is used for detecting the at least one light ray or the image sent by the electronic apparatus 100B. A higher resolution of the design for the light sensor 105 is not required; however, this is not meant to be a limitation. Further, the processing circuit 110 of electronic apparatus 100A is coupled to the light sensor 105 and used for decoding the detected light ray or image to generate the decoded pairing data and then making the electronic apparatuses 100A and 100B successfully pair with each other for wireless communication according to the decoded pairing data. Further, an error correction code scheme can be applied into the operation of encoding the pairing data, in order to more accurately transmit the pairing data based on the brightness variation(s), color variation(s), and/or specific pattern(s) (or pattern variation(s)).

Specifically, for example, when the electronic apparatuses 100A and 100B are respectively an optical mouse device and a display device, the operation of actively initiating the wireless communication pairing scheme can be executed by the display device (i.e. the electronic apparatus 100B) or by the optical mouse device (i.e. the electronic apparatus 100A). When a user would like to use the optical mouse device for operating and controlling the display device, the user can pick up the optical mouse device and then aim the bottom of the optical mouse device at a certain display area on a screen of the display device. It is not required for the bottom of the optical mouse device to contact or touch the screen of the display device. The display device is arranged for displaying image(s) on the at least display area of the screen to transmit and indicate at least one of brightness variation(s), color variation(s), and specific pattern variation(s), so as to encode and carry the pairing data on the brightness variation(s), color variation(s), and/or specific pattern variation(s). The optical mouse device can sense the brightness variation(s), color variation(s), and/or specific pattern variation(s) by using the light sensor 105, and can decode the pairing data by using the processing circuit 110.

The light sensor 105 can be further used as a sensor for optical positioning. That is, in addition to use the sensor 105 of the optical mouse device for optical positioning of the optical mouse device, the user can also aim the bottom of the optical mouse device at the display device to make the sensor 105 sense and receive brightness variation(s), color variation(s), and specific pattern variation(s) when the optical mouse device tries to pair with the display device for wireless communication. By doing so, the pairing data can be decoded by a post-stage circuit within the optical mouse device, and the optical mouse device can successfully pair with the display device for wireless communication. Thus, it is not required for the user to manually enter pairing data or associated data for wireless communication during the whole procedure of the wireless communication pairing scheme. If the user would like to use an optical mouse device to operate a cursor on a computer screen, it is only necessary for the user to make the bottom of the optical mouse device to close and face to the computer screen, and then the optical mouse device can successfully pair with the computer device. Thereafter, the user can immediately use the optical mouse device to operate and control the cursor on the computer screen. Compared with the conventional scheme, it is more convenient for the user to employ the automatic wireless communication pairing scheme disclosed in the embodiment of the invention, and the system efficiency can be improved.

Additionally, in other embodiments, the above-mentioned electronic apparatuses 100A and 100B can be a mobile communication device (e.g. a smart phone device) and a display device respectively. The operation of actively initiating the wireless communication pairing scheme can be executed by the display device (i.e. electronic apparatus 100B) or the smart phone device (i.e. electronic apparatus 100A). If a user would like to use the smart phone device for operating and controlling the display device, the user can pick up the smart phone device and aim the front camera or rear camera at a display area on a screen of the display device. In this example, it is not required for the smart phone device to contact the display screen. The display device is arranged for displaying image(s) on at least one display area of its screen to transmit and indicate at least one of brightness variation(s), color variation(s), and specific pattern variation(s), so as to encode and carry the pairing data on the brightness variation(s), color variation(s), and/or specific pattern variation(s). The smart phone device can sense the brightness variation(s), color variation(s), and/or specific pattern variation(s) by using the light sensor 105 to obtain the pairing data and then decode the pairing data by using the processing circuit 110. The light sensor 105 of smart phone device can be a sensor of front camera and/or a sensor of rear camera. That is, in addition to using the light sensor 105 of smart phone device for sensing image(s) to be photographed, a user can aim the front camera and/or the rear camera of the smart phone device at the display device of a computer to sense and receive brightness variation(s), color variation(s), and/or specific pattern variation(s) when the user would like to make the smart phone device pair with the computer or the display device for wireless communication. A post-stage circuit (i.e. the processing circuit 110) within the smart phone device can be used for decoding the pairing data so that the smart phone device can successfully pair with the computer or the display device. During the whole procedure of wireless communication pairing, it is not required for the user to manually enter the pairing data or associated data into one electronic apparatus. Also, it is not required for the user to press any key(s) to execute the procedure of the wireless communication pairing scheme. If the user would like to use the smart phone device for operating the screen of display device to achieve the control of data streaming via wireless communication, the user merely requires to make the front camera or rear camera of the smart phone device close and face to the screen of display device, and then the smart phone device can successfully pair with the display device. Thereafter, the user can immediately use the smart phone device to operate and control the display device. Compared with the conventional scheme, it is more convenient for the user to employ the automatic wireless communication pairing scheme disclosed in the embodiment of the invention, and the system efficiency can be improved.

Additionally, in other embodiments, the above-mentioned electronic apparatuses 100A and 100B can be a pair of mobile communication devices such as smart phone devices. The operation of actively initiating the wireless communication pairing scheme can be executed by the electronic apparatus 100B or by the electronic apparatus 100A. For example, if a user would like to use a smart phone device to pair with another smart phone device for achieving data transmission or data sharing, the user can pick up the smart phone device and aim the front camera or rear camera at a display screen of the another smart phone device. In this example, it is not required for the smart phone device to contact another smart phone device. The another smart phone device is arranged for displaying image(s) on at least one display area of its display screen to transmit and indicate at least one of brightness variation(s), color variation(s), and specific pattern variation(s), so as to encode and carry the pairing data on the brightness variation(s), color variation(s), and/or specific pattern variation(s). The smart phone device can sense the brightness variation(s), color variation(s), and/or specific pattern variation(s) by using the light sensor 105 to obtain the pairing data and then decode the pairing data by using the processing circuit 110. During the whole procedure of wireless communication pairing, it is not required for the user to manually enter the pairing data or associated data into one smart phone device. Also, it is not required for the user to press any key(s) to execute the procedure of the wireless communication pairing scheme. If the user would like to execute the function of data transmission or data sharing between two smart phone devices, the user merely requires to enable and make the front camera or rear camera of the smart phone device close and face to the display screen of another smart phone device, and then the two smart phone devices can successfully pair with each other to achieve the purpose of data transmission and data sharing. Compared with the conventional scheme, it is more convenient for the user to employ the automatic wireless communication pairing scheme disclosed in the embodiment of the invention, and the system efficiency can be improved.

Additionally, in another embodiment, the optical mouse device can be used for encoding the pairing data of the wireless communication pairing scheme and transmit the encoded pairing data to the screen of the display device based on at least one of brightness variation(s), color variation(s), and pattern variation(s). Thereafter, the display device (with a built-in image sensor) is arranged for sensing and decoding the pairing data to execute the wireless communication pairing scheme successfully. In this embodiment, the display device is implemented by using the electronic apparatus 100A including the light sensor 105 and processing circuit 110. The optical mouse device is implemented by using the electronic apparatus 100B including the processing circuit 115 and optical display device 120. The light sensor 105 for example can implemented and installed on an area of the screen of the display device, and the optical display device 120 for example can be implemented by using a display screen of an optical mouse device and be used as an optical emitter. Through the display screen of the optical mouse device to generate and emit the light ray carrying the pairing data to the screen of display device, the light sensor 105 installed on the screen of the display device can sense the pairing data to successfully perform the operation of wireless communication pairing scheme.

Further, in another embodiment, the smart phone device can be used for encoding the pairing data for wireless communication and transmit the encoded pairing data to the screen of the display device based on at least one of brightness variation(s), color variation(s), and pattern variation(s). Thereafter, the display device can be arranged for sensing and decoding the pairing data to perform the wireless communication pairing scheme successfully. In this embodiment, the display device is implemented by using the electronic apparatus 100A including the light sensor 105 and processing circuit 110. The smart phone device is implemented by using the electronic apparatus 100B including the processing circuit 115 and optical display device 120.

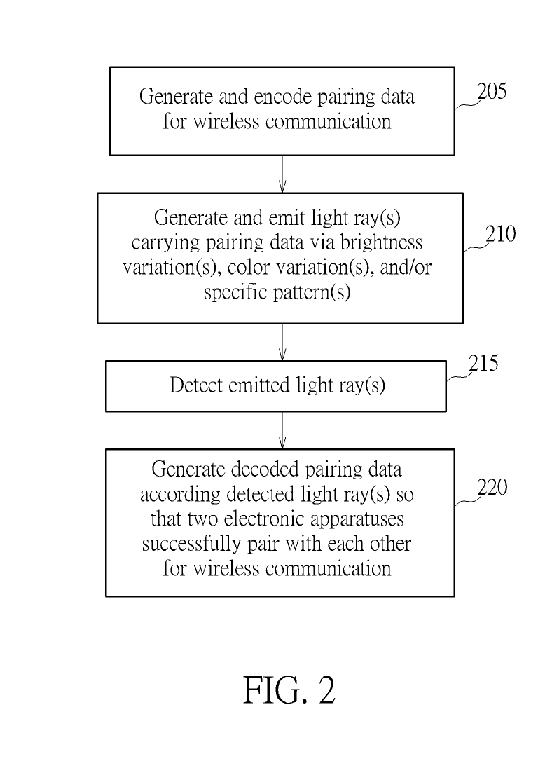

In order to more clearly describe the spirits of embodiments of the invention for readers, FIG. 2 is provided and is a flowchart diagram illustrating operations of the system of wireless communication pairing as shown in FIG. 1. Provided that substantially the same result is achieved, the steps of the flowchart shown in FIG. 2 need not be in the exact order shown and need not be contiguous, that is, other steps can be intermediate. The steps of FIG. 2 are detailed in the following:

Step 205: An electronic apparatus generates and encodes pairing data for wireless communication;

Step 210: The electronic apparatus generates and emits light ray(s) carrying the pairing data based on at least one of brightness variation(s), color variation(s), and specific pattern(s);

Step 215: Another electronic apparatus detects the emitted light ray(s); and

Step 220: The electronic apparatus generates decoded pairing data according the detected light ray(s) so that the two electronic apparatuses successfully pair with each other for wireless communication.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A first electronic apparatus capable of pairing with a second electronic apparatus for wireless communication, comprising:
a light sensor, for detecting at least one light ray emitted by the second electronic apparatus; and
a processing circuit, coupled to the light sensor, for decoding the at least one emitted light ray to generate decoded pairing data, and making the first electronic apparatus pair with the second electronic apparatus for the wireless communication according to the decoded pairing data;
wherein the at least one emitted light ray carrying the pairing data is generated by the second electronic apparatus based on at least one of brightness variation(s), color variation(s), and pattern variation(s).

2. The first electronic apparatus of claim 1, wherein the first electronic apparatus pairs with the second electronic apparatus for Bluetooth wireless communication.

3. The first electronic apparatus of claim 1, wherein the first electronic apparatus is a portable device, and the second electronic apparatus is a display device; the light sensor of the portable device is arranged to detect at least one image displayed by a screen of the display device; and, the display device is arranged to generate the at least one image carrying with the pairing data based on at least one of brightness variation(s), color variation(s), and pattern variation(s).

4. The first electronic apparatus of claim 3, wherein the first electronic apparatus is an optical mouse device, and the light sensor of the optical mouse device is further used for positioning the optical mouse device.

5. The first electronic apparatus of claim 1, wherein the first electronic apparatus is a mobile communication device; the light sensor is an image sensor of the mobile communication device, and the second electronic apparatus is a display device or another different mobile communication device; the image sensor of the mobile communication device is arranged to detect at least one image displayed by a screen of the display device or displayed by a screen of the different mobile communication device; and, the at least one image carrying with the pairing data is generated by the display device or by the different mobile communication device based on at least one of the brightness variation(s), the color variation(s), and the pattern variation(s).

6. The first electronic apparatus of claim 1, wherein the first electronic apparatus is a display device; the light sensor is a sensor of a screen of the display device, and the second electronic apparatus is a portable device; and, the sensor of the screen of the display device is used for detecting the at least one light ray emitted by the portable device.

7. The first electronic apparatus of claim 6, wherein the second electronic apparatus is an optical mouse device, and the at least one light ray emitted by the optical mouse device is further used for optical positioning for the optical mouse device.

8. A method for making a first electronic apparatus pair with a second electronic apparatus for wireless communication, comprising:
detecting at least one light ray emitted by the second electronic apparatus;
decoding the at least one emitted light ray to generate decoded pairing data; and
making the first electronic apparatus pair with the second electronic apparatus for the wireless communication according to the decoded pairing data;
wherein the at least one emitted light ray carrying the pairing data is generated by the second electronic apparatus based on at least one of brightness variation(s), color variation(s), and pattern variation(s).

9. The method of claim 8, wherein the first electronic apparatus is a portable device, the second electronic apparatus is a display device, and the step of using the light sensor of the first electronic apparatus to detect the at least one light ray emitted by the second electronic apparatus comprises:
using the light sensor of the portable device to detect at least one image displayed on a screen of the display device;
wherein the display device is arranged to generate the at least one image carrying the pairing data based on at least one of the brightness variation(s), the color variation(s), and the pattern variation(s).

10. The method of claim 9, wherein the first electronic apparatus is an optical mouse device, and the light sensor of the optical mouse device is further used for positioning the optical mouse device.

11. The method of claim 8, wherein the first electronic apparatus is a mobile communication device; the light sensor is an image sensor of the mobile communication device, and the second electronic apparatus is a display device or another different mobile communication device; and the step of using the light sensor of the first electronic apparatus to detect the at least one light ray emitted by the second electronic apparatus comprises:
using the image sensor of the mobile communication device to detect at least one image displayed by a screen of the display device or displayed by a screen of the different mobile communication device;
wherein the at least one image carrying the pairing data is generated by the display device or by the different mobile communication device based on at least one of the brightness variation(s), the color variation(s), and the pattern variation(s).

12. The method of claim 8, wherein the first electronic apparatus is a display device; the light sensor is a sensor of a screen of the display device, and the second electronic apparatus is a portable device; and, the step of using the light sensor of the first electronic apparatus to detect the at least one light ray emitted by the second electronic apparatus comprises:
using the sensor of the screen of the display device detect the at least one light ray emitted by the portable device.

13. The method of claim 12, wherein the second electronic apparatus is an optical mouse device, and the at least one light ray emitted by the optical mouse device is further used for optical positioning for the optical mouse device.

14. A first electronic apparatus capable of actively pairing with a second electronic apparatus for wireless communication, comprising:
a processing circuit, for generating pairing data for wireless communication; and
an optical display device, coupled to the processing circuit, for generating and emitting at least one light ray carrying the pairing data to the second electronic apparatus based on at least one of brightness variation(s), color variation(s), and pattern variation(s) according to the pairing data.

15. The first electronic apparatus of claim 14, wherein the first electronic apparatus is a display device, and the optical display device is a screen of the display device; and, the screen is arranged to generate and emit at least one image carrying the pairing data to the second electronic apparatus based on at least one of the brightness variation(s), the color variation(s), and the pattern variation(s) according to the pairing data.

16. The first electronic apparatus of claim 14, wherein the first electronic apparatus is an optical mouse device, and the second electronic apparatus is a display device; and, the optical display device is an optical light emitter of the optical mouse device; and, the optical light emitter is arranged to generate and emit the at least one light ray carrying the pairing data to a screen of the display device.
